(19) United States
(12) Patent Application Publication
(10) Pub. No.: US 2016/0239915 A1
(43) Pub. Date: Aug. 18, 2016

(54) SYSTEM AND METHOD FOR TRADING REPURCHASE AGREEMENTS

(71) Applicant: Tradeweb Markets LLC, New York, NY (US)

(72) Inventors: James Dale, Esher (GB); Paul Jones, Dublin (IE)

(21) Appl. No.: 15/046,040

(22) Filed: Feb. 17, 2016

Related U.S. Application Data
(60) Provisional application No. 62/117,758, filed on Feb. 18, 2015.

(51) Int. Cl. G06Q 40/04

(52) U.S. Cl. CPC G06Q 40/04

(57) ABSTRACT

A trading platform for trading financial instruments, and in particular for generating pre-trade prices. In an exemplary embodiment, the trading platform includes computer software modules and provides graphical user interfaces to accept dealer bids and offers, aggregate the dealer positions, generate a pre-trade price, permit dealers to opt-in to a matching process (the sweep), and determine matches by comparing the positions and potential opposing positions. The trading systems and methods may generate a yield curve from the dealer bids and offers which may be used for the valuation of positions and collateral. The trading platform is also capable of matching orders and sending orders to be executed.

### CROSS-REFERENCE TO RELATED APPLICATION

This application claims the benefit of U.S. Provisional Patent Application No. 62/117,758, entitled SYSTEM AND METHOD FOR TRADING REPURCHASE AGREEMENTS, filed on Feb. 18, 2015, the contents of which are incorporated herein by reference.

### BACKGROUND OF THE INVENTION

1. Field of the Invention

The embodiments of the present invention relate to systems and methods for trading financial instruments such as “repurchase agreements” (“repos”).

2. Description of Related Art

The repo market as it exists today consists of individual buyers and individual sellers making bids or offers and waiting for a potential cross match. Accordingly, many repo transactions are bilateral contracts or conducted via a central counterparty (CCP). Large scale repo traders will often have balance sheets with large numbers of contracts. The balance sheets typically include multiple counter-parties, requiring significant capital allocations and brokerage costs.

Repo transactions include an additional dimension compared with many other securities transactions (i.e., the duration of the repo) and therefore include a correspondingly larger number of potential price points. Furthermore, an initial repo inquiry may not include a proposed rate. Repo markets therefore lack readily available independent market data to identify appropriate rate curves. As such, brokers are unable to generate pre-trade prices.

Accordingly, there is a need for efficient systems and methods of managing a centralized repo netting system that permits aggregating repo assets and liabilities so they may be offset on balance sheets. Additionally, there is a need for efficient systems and methods for generating pre-trade repo price curves and for balance sheet netting of repo transactions.

### SUMMARY

In view of the above discussion and the shortcomings in the prior art, the invention seeks to overcome such shortcomings of the prior art by providing various systems and methods which generally generate pre-trade repo rates and match individual dealers opposing positions in repos with a view toward balance sheet netting, reducing balance sheets in trades, and increasing balance sheet efficiency. The trading systems and methods may generate a yield curve from the dealer bids and offers which may be used for the valuation of positions and collateral.

According to one embodiment of the present invention, a system for generating one or more pre-trade prices and matching trades is in communication with a plurality of dealers associated with a plurality of dealer computer systems. In this embodiment, the system includes an order entry module with one or more sub-routines operative to accept trade order data from the plurality of dealers, a rate generation module with one or more sub-routines operative to generate one or more pre-trade prices based on the trade order data, a size confirmation module with one or more sub-routines operative to permit the plurality of dealers to provide updated trade order data based on the one or more pre-trade prices, a sweep module with one or more sub-routines operative to match trades based on the updated trade order data and to execute the matched trades, and a trade reporting module with one or more sub-routines operative to provide each dealer who matched a trade with trade data for each trade matched by that dealer. Some embodiments additionally include a volatility module with one or more sub-routines operative to generate an indication of market volatility, wherein the indication activates a volatility notification to one or more dealers and permits the one or more dealers to cancel a trade session. In some embodiments, the trade reporting module additionally includes one or more sub-routines operative to provide matched trade data to at least one or more settlement agents or to one or more clearers.

According to one embodiment of the present invention, a method for generating one or more pre-trade prices and matching trades comprises accepting trade order data from a plurality of dealers associated with a plurality of dealer computer systems, generating one or more pre-trade prices based on the trade order data, permitting the plurality of dealers to provide updated trade order data based on the one or more pre-trade prices, matching trades based on the updated trade order data, executing the matched trades, and providing each dealer who matched a trade with trade data for each trade matched by that dealer. Some embodiments additionally include generating an indication of market volatility, wherein the indication activates a volatility notification to one or more dealers and permits the one or more dealers to cancel a trade session. Some embodiments additionally include providing at least one or more settlement agents or one or more clearers with matched trade data.

According to one embodiment of the present invention, a system for generating one or more pre-trade prices and matching trades is in communication with a plurality of dealers associated with a plurality of dealer computer systems. In this embodiment, the system includes an order entry module with one or more sub-routines operative to accept trade order data from the plurality of dealers, means for generating one or more pre-trade prices based on the trade order data, a size confirmation module with one or more sub-routines operative to permit the plurality of dealers to provide updated trade order data based on the one or more pre-trade prices, a sweep module with one or more sub-routines operative to match trades based on the updated trade order data and to execute the matched trades, and a trade reporting module with one or more sub-routines operative to provide each dealer who matched a trade with trade data for each trade matched by that dealer. Some embodiments additionally include a volatility module with one or more sub-routines operative to generate an indication of market volatility, wherein the indication activates a volatility notification to one or more dealers and permits the one or more dealers to cancel a trade session. In some embodiments, the trade reporting module additionally includes one or more sub-routines operative to provide matched trade data to at least one or more settlement agents or to one or more clearers.

In some embodiments, the trade order data includes risk limits. In some embodiments, the one or more pre-trade prices maximize trade volume. In some embodiments, the trade order data includes custom terms. In some embodiments, a dealer is not provided with opposing dealer positions unless the dealer matches a trade.

### BRIEF DESCRIPTION OF THE DRAWINGS

The foregoing summary, as well as the following detailed description of preferred embodiments of the application, will be better understood when read in conjunction with the appended drawings wherein like reference numerals refer to like components. For the purposes of illustrating the device of the present application, there is shown in the drawings preferred embodiments. It should be understood, however, that the application is not limited to the precise arrangement, structures, features, embodiments, aspects, and devices shown, and the arrangements, structures, features, embodiments, aspects and devices shown may be used singularly or in combination with other arrangements, structures, features, embodiments, aspects and devices.

The drawings are not necessarily drawn to scale and are not in any way intended to limit the scope of this invention, but merely to clarify a single illustrated embodiment of the invention. In the drawings:

FIG. 1 is a diagram of an exemplary embodiment of a trading system in communication with various user computers;

FIG. 2 is a process flow diagram of an exemplary embodiment of the trading system;

FIG. 3 is a screen shot depicting an exemplary graphical user interface and various features of an exemplary embodiment of a trading system order entry screen;

FIG. 4 is a screen shot depicting an exemplary graphical user interface and various features of an exemplary embodiment of a trading system order entry screen;

FIG. 5 is a chart depicting various example desired dealer bids and offers according to one embodiment of the present invention;

FIG. 6 is a screen shot depicting an exemplary graphical user interface and various features of an exemplary embodiment of a trading system during a confirmation phase;

FIG. 7 is a screen shot depicting an exemplary graphical user interface and various features of an exemplary embodiment of a trading system during a confirmation phase;

FIG. 8 is a screen shot depicting an exemplary graphical user interface and various features of an exemplary embodiment of a trading system after the sweep is completed;

FIG. 9 is a screen shot depicting an exemplary graphical user interface and various features of an exemplary embodiment of a trading system after the sweep is completed.

### DESCRIPTION OF CERTAIN EMBODIMENTS OF THE INVENTION

In general, a computerized electronic trading system and method permits a user (e.g., a dealer) using a user computer to electronically request opposing security position matches held by other market participants (e.g., other dealers) having a computer (e.g., a dealer computer). The centralized computer system includes one or more computers and at least one message server for communicating electronic messages to and between the user computer, dealer computer, and a database system including at least one storage device such as memory, the database system storing at least data related to security positions of various market participants. The computerized electronic trading system may be programmed with a matching engine such as a matching and criteria module, including one or more sub-components to handle security position data, identify matching security positions, determine minimums, and prioritize matches and/or positions.

Embodiments of the invention disclosed herein may preferably be integrated into electronic trading platforms. Trading platforms are well known in the art, for example, as disclosed in U.S. Pat. No. 7,433,842, entitled METHOD AND SYSTEM FOR EFFECTING STRAIGHT-THROUGH-PROCESSING OF TRADES OF VARIOUS FINANCIAL INSTRUMENTS, issued Oct. 7, 2008 and filed Mar. 25, 2004 as U.S. patent application Ser. No. 10/808,820, the entirety of which is incorporated herein by reference.

Embodiments of the invention disclosed herein may also utilize matching systems, such as, for example, those disclosed in U.S. patent application Ser. No. 12/907,667, entitled METHOD AND SYSTEM FOR IDENTIFYING HIGH PROBABILITY TRADE MATCHES, filed Oct. 19, 2010, the entirety of which is incorporated herein by reference, and those disclosed in U.S. patent application Ser. No. 14/215,992, entitled SYSTEM AND METHOD FOR FINANCIAL MATCHING, filed Mar. 17, 2014, the entirety of which is incorporated herein by reference.

In an exemplary embodiment, the concept of an electronic session based matching process can be used to accept dealer bids and offers, aggregate the dealer positions, generate a pre-trade price, permit dealers to opt-in to a matching process (the “sweep”), and determine matches by comparing the positions and potential opposing positions. A trading system 1 that may include various software modules for execution of various processes and that is connectable with dealer via the dealer's computers is preferably provided.

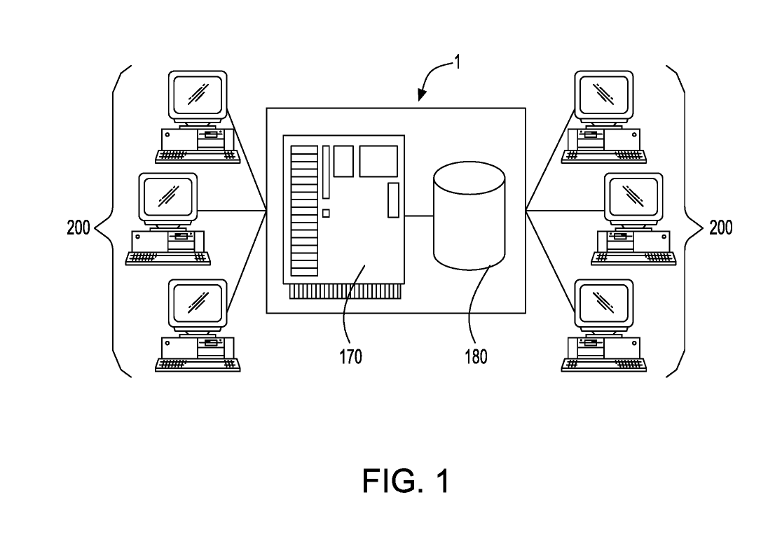

In an exemplary embodiment, a computerized electronic trading system and method includes a plurality of dealer computers, a database system including at least one system storage device such as memory, at least one message server and a matching engine such as a matching and criteria module. For example, FIG. 1 shows an exemplary embodiment of a trading system 1 in communication with various dealer computers 200. The trading system 1 preferably includes one or more computer systems 170 that can include one or more software modules as described below, databases 180, and related database management systems.

In an exemplary embodiment, the computerized electronic trading system and method includes three phases: a rate generation phase, a size-confirmation phase and a sweep phase. During these phases, dealers may enter desired positions, and the trading system may aggregate the desired dealer positions, generate a pre-trade price, permit dealers to opt-in to a matching process (the sweep), and determine matches by comparing the positions and potential opposing positions. Where a match occurs, the trade matches at the pre-trade price and may be processed straight through into the dealers on both sides of the trade using risk and/or booking systems.

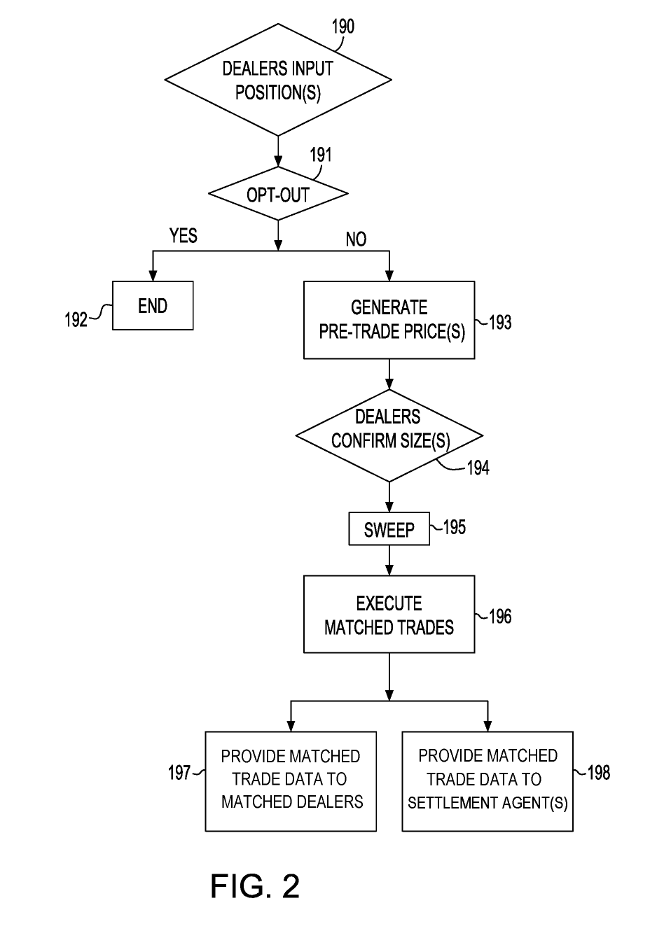

A process flow diagram of an exemplary embodiment of the trading system is depicted in FIG. 2. In step 1 (190), dealers initially input positions into the trading system. In step 2 (191), the trading system may permit dealers to opt-out, for example, in response to various triggering events such as excessive Euro OverNight Index Average (“Eonia”) and/or Sterling Over Night Index Average (“Sonia”) volatility. If the dealers opt-in, in step 3 (193), the trading system generates a pre-trade price (session price), for example, for each tenor. In step 4 (194), the dealers confirm their desired trade sizes at each generated price. In step 5 (195), the trading system performs the sweep to match trades. In step 6 (196), the system executes the matched trades, and in step 7 (197), the system provides each dealer who matched a trade with trade data for each trade matched by that dealer. In step 8 (198), the trading system may provide matched trade data to one or more settlement agents and/or clearer (clearing house). Computer systems 170 may include one or more modules each with one or more sub-routines operative to perform any or all of the process steps depicted in FIG. 2, or any portion thereof. For example, computer systems 170 may include an order entry module to accept trade order data as discussed in more detail below, a rate generation module for generating one or more pre-trade prices based on the trade order data as discussed in more detail below, a size confirmation module to permit the dealers to provide updated trade order data based on the one or more pre-trade prices as described in more detail below, a sweep module to match trades based on the updated trade order data and to execute the matched trades as described in more detail below, and a trade reporting module to provide each dealer who matched a trade with trade data for each trade matched by that dealer as discussed in more detail below.

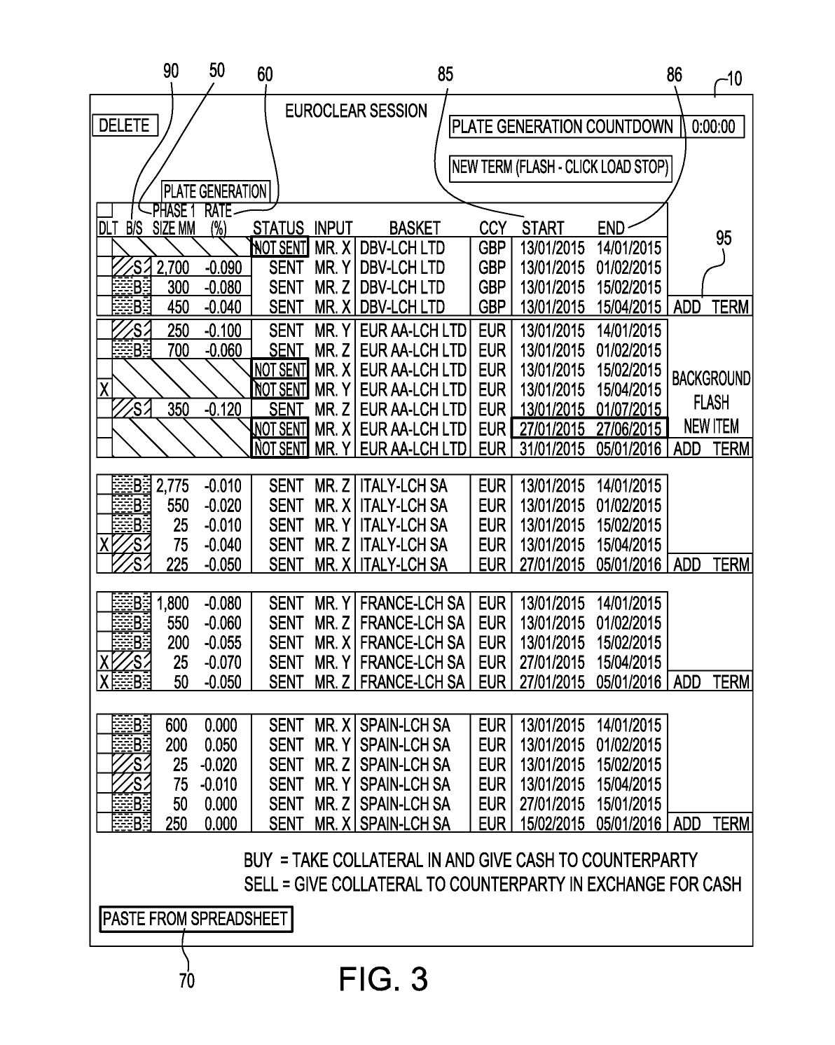

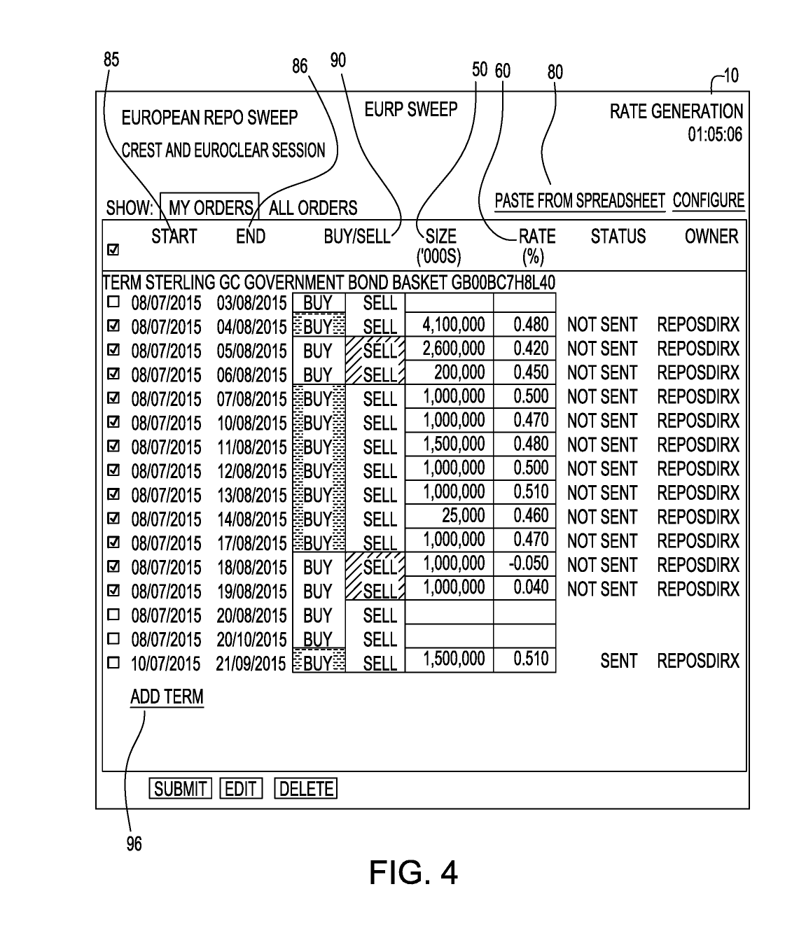

Rate Generation Phase. In an exemplary embodiment, dealers provide positions to the trading system which they wish to net during a rate generation phase, for example, through the use of an order entry screen which may permit copying and pasting positions from an Excel spreadsheet. Exemplary embodiments of the trading system graphical user interface and order entry screen are illustrated in FIGS. 3 and 4.

For example, the trading system 1 preferably provides the dealers a trading platform graphical user interface (GUI), such as GUI 10, alternative embodiments of which are depicted in FIGS. 3 and 4. In an exemplary embodiment, GUI 10 includes an order entry screen to allow dealers to enter orders. The dealers may contribute positions, for example, by manually inputting a desired trade size in column 50 and a desired rate in column 60 in a given tenor, or by activating button 70, link 80 or the like to paste positions from a spreadsheet (or any other database/list), such as via an Excel upload. In some embodiments, the trading system 1 permits dealers to seek trading positions in an anonymous manner (such that positions will not be known to other dealers except in the instance where they match a specific position with another dealer). In some embodiments, the rate generation phase occurs from the beginning of the day until some fixed time, for example, ten minutes before the sweep.

The trading system is preferably capable of accepting data for each tenor (i.e., the term length, for example, designated by start date column 85 and end date column 86) and from each dealer relating to, without limitation, a position's direction 90 (buy/sell), desired trade size 50, and desired rate 60 during the pre-set time period. In some embodiments, dealers may not enter two-way markets, negative sizes or prices outside pre-specified ranges. Negative rates may be allowed. In some embodiments, the tenors are predefined, in other embodiments, dealers may enter bespoke or custom terms, for example, by activating add term button 95 as shown in FIG. 3 or add term link 96 as shown in FIG. 4. If a dealer enters a bespoke repo term, built-in calendars may ensure only valid dates are available for each market, for example, by only permitting start and end dates that fall on valid trading days, by limiting maturity dates to some fixed duration such as 364 days, or otherwise; the trading system may alert other dealers of the bespoke term by populating the new tenor on each dealer's interface. The trading system may also be programmed to accept data relating to a risk tolerance, which may be a cash price or spread above/below which the dealer prefers not to trade). Dealers may send each desired position with the press of a button. In some embodiments, various triggering events, for example, excessive Eonia/Sonia volatility, may allow a trader to cancel a session during this phase, even after sending potential repo positions.

Once the time for entering desired trades has ended, the trading system may then aggregate the dealers' desired positions and generate rates for the sweep. For example, a rate may be generated for crossed rates, for example, by taking the mid-point of the price range that maximizes traded volume, and for non-crossed rates, for example, by taking the mid-point between the best bid and offer for two-sided markets or the best bid or offer for one-sided markets. In some embodiments, the calculated rate may seek to maximize trade volume, incentivize liquidity providers, or the like.

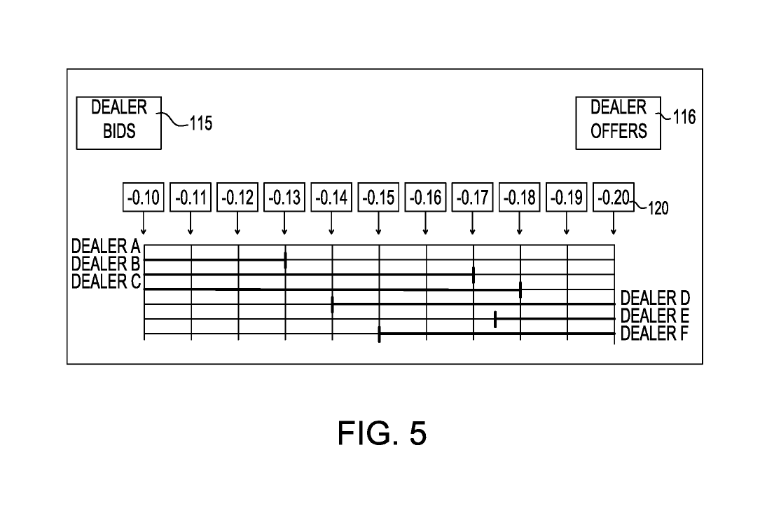

FIG. 5 depicts an exemplary scenario where dealers A-F have input various bids 115 and offers 116 at negative rates graphed on axis 120. When the system aggregates dealers' positions, it may determine, based on each dealer's desired position, a rate range at which each dealer would be willing to trade. For example, if a dealer would buy (i.e., take collateral in and give cash to the counterparty) at a rate of −13% (see Dealer A in FIG. 5), the trading system may determine that the dealer's desired range includes any rate greater than or equal to −13%. Similarly, if a dealer would sell (i.e., give collateral to the counterparty in exchange for cash) at a rate of −14% (see Dealer D in FIG. 5), the trading system may determine that the dealer's desired range includes any rate less than or equal to −14%.

Once the positions are aggregated, the system may determine whether or not there is a crossed price market. If there is a crossed price market, the trading system may, in one embodiment, maximize trade volume. For example, if each dealer submits the prices illustrated in FIG. 5 and each requests the same quantities, the price range which maximizes traded volume is −0.15 to −0.17, so the price for the session would be set at the mid-point, −0.16. In another example, if each dealer submits the prices illustrated in FIG. 5, but dealers A, B, D and F desire quantities of 100 MM, while dealers C and E request 1 BN each. The price range which maximizes traded volume is −0.175 to −0.18, so the price for the session would be set at the mid, —0.177. In some embodiments, the price may be skewed to the cash provider, so, for example, −0.1775 may be rounded to −0.177. If prices do not cross, the system may simply take the mid-point of the best bid and best offer prices. For one-sided markets where there is only one bidder or one offeror, the price generated may simply be the best bid or offer. The result is a rate generated for each product line (distinct repo term) and at which each dealer may enter into the sweep.

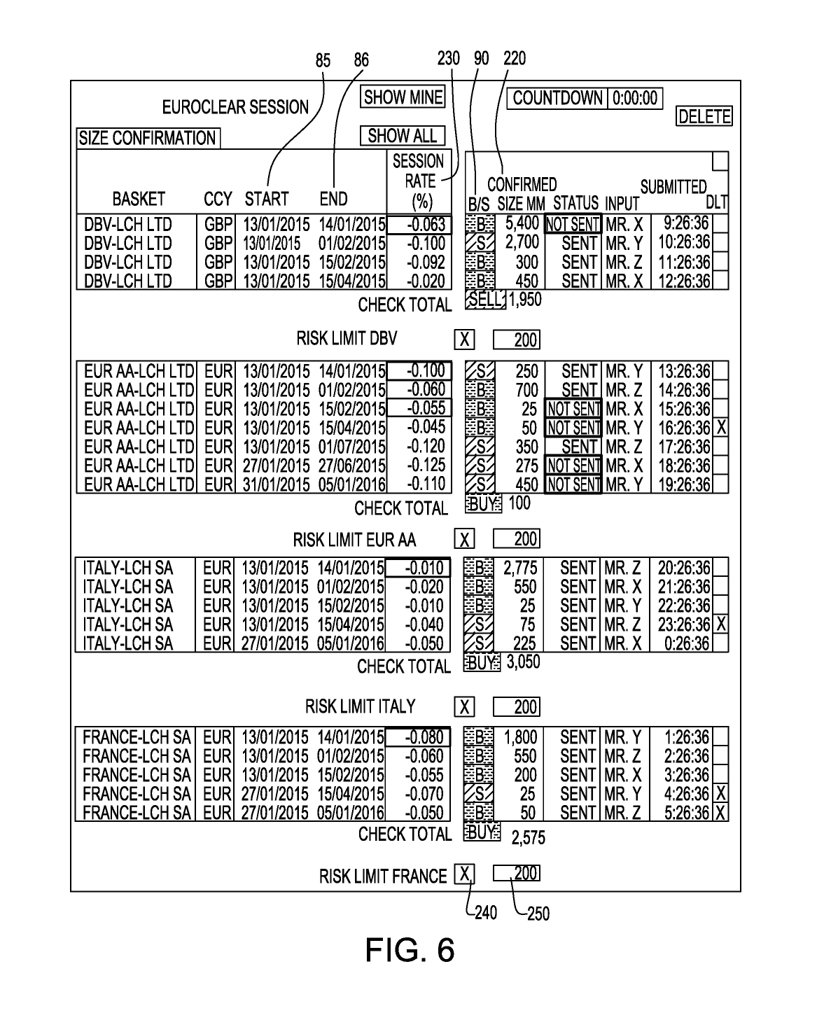

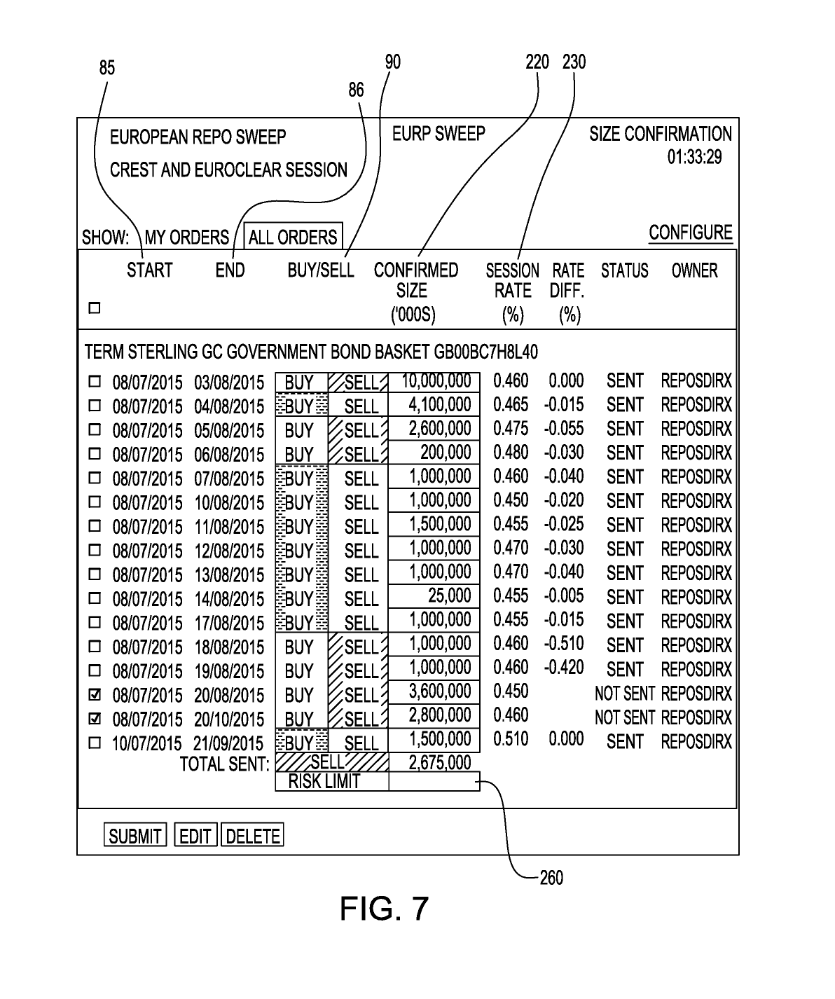

Size-Confirmation Phase Some embodiments include a confirmation phase, which begins after the rate generation phase has ended and may last for some fixed period of time (e.g., 10 minutes). During this phase, the dealers may be asked to confirm entry into the sweep at the proposed rates determined during the rate generation phase. Exemplary embodiments of the trading system graphical user interface during a confirmation phase are illustrated in FIGS. 6 and 7.

In some embodiments, each dealer's desired trade sizes that were previously entered are automatically populated as the default sizes in column 220 for the sweep at the proposed rates in column 230 for each potential repo trade. Dealers may have, for example, ten minutes to confirm the default sizes, adjust their desired trade sizes, or opt out of the sweep. Alternatively, dealers may be required to affirmatively opt in to the sweep. In some embodiments, dealers can also enter sizes and directions into other tenors, even though they did not previously participate in the rate generation at the tenor.

Dealers may be able to override or edit confirmed sizes (and directions for newly participating repos) until the confirmation stage ends. In some embodiments, dealers may opt into and enter risk limits during the confirmation phase. For example, dealers may enter an absolute value of the [symbol] difference from zero net fill for all net positions, for trade baskets regardless of duration (e.g., by activating check box 240 and entering a desired risk limit in entry field 250 in FIG. 6, or by entering a desired risk limit in entry field 260 in FIG. 7), or for individual repos. Once opted in, the default risk limit may be calculated as the net of total current inputs (i.e., value of the sum of the longs and shorts, for example, in euros).

Sweep Phase Next, during the sweep phase, the matching engine matches opposing positions of the traders who have opted into the sweep during the confirmation phase. In an exemplary embodiment, the trading system first creates provisional fills determined by a prioritization algorithm, and then adjusts the provisional fills to account for various limits, for example, risk limits, trade limits and the like, and then reshaping the provisional fills by adjusting the fills of those participants over their limits. For example, the trading system may provisionally order participants on each side of the market (over limit—long risk/short risk) and then iteratively break/alter trades between the dealer who is most over their limit on the long side and the dealer who is most over their limit on the short side, filling those empty trades with participants who are not matched.

In some embodiments, the provisional fills may prioritize (in order):
crossed contributors (i.e., where participants have crossed rates) and best bid/offer from the rate generate phase (i.e., better prices get priority where there are multiple crosses);
highest fill prioritization ratio (see below); and
where fill prioritization ratios are tied, give priority to the largest liability provider (i.e., to incentivize the participation of cash providers).
   The above criteria is non-limiting and as can be appreciated by one of ordinary skill in the art, additional characteristics can also be used to help prioritize the fills.

A fill prioritization ratio may be defined, for example, as the ratio of liability to assets (i.e., total bids/total offers) using the sizes from the confirmation stage and converted to one currency to facilitate one ratio for all baskets entered. In some embodiments, the fill prioritization ratio is only considered for two sided markets to prevent potential gaming of the system.

After completing the provisional fills, the trading system may then adjust the fills for any dealer risk limits. For example, the system may iteratively break trades where dealers have exceeded a risk limit and fill each broken trade with an unmatched dealer. Because longer tenor trades are more challenging to match, the shorter duration trades may be broken and refilled first. Similarly, priority may be given to crossers and best bid/offer participants, so fills for participants who were not crossers or best bid/offer participants may be broken and refilled earlier in the process. An exemplary order to remove trades in risk limit shaping may include:
Shorter tenor trades where the participant did not contribute for that tenor in Phase 1.
Shorter tenor trades from bid/offer markets of participants who were not best bid and offer in Phase 1.
Shorter tenor trades from Crossed markets of participants who were not crossers in Phase 1.
Shorter tenor trades of the best bid/offer participants in Phase 1.
Shorter tenor trades of crossers (remove in price order least to most aggressive) in Phase 1.
Longer trades where the participant did not contribute for that tenor in Phase 1.
Longer tenor trades from bid/offer markets of participants who were not best bid and offer in Phase 1.
Longer tenor trades from Crossed markets of participants who were not crossers in Phase 1.
Longer tenor trades from the best bid/offer participants in Phase 1.
Longer tenor trades of crossers (remove in price order least to most aggressive) in Phase 1.
   The process is complete when all participants are below their specified risk limits and fills have been reshaped using prior unmatched offers/bids to obtain maximum volume.

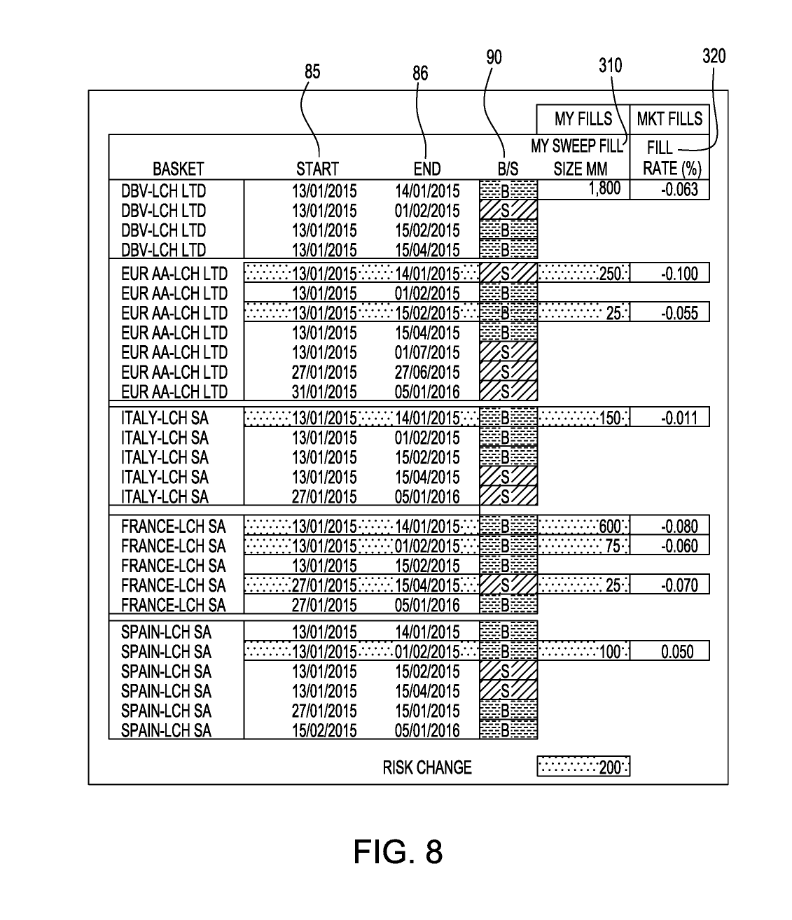

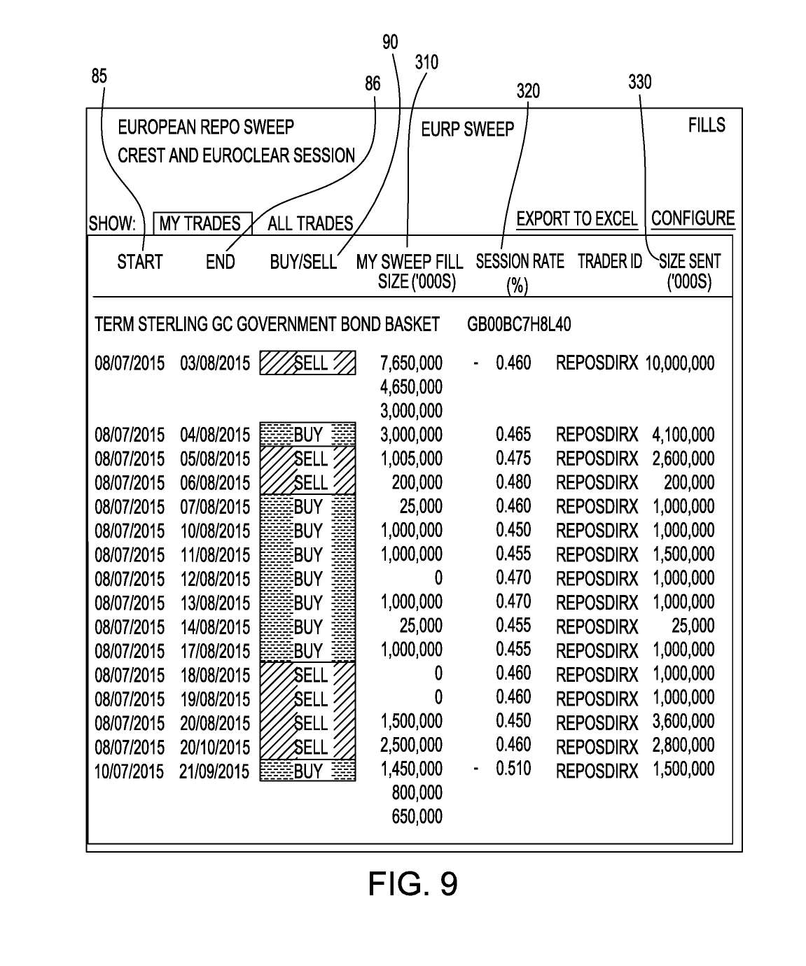

Once the trading system has completed the sweep, the full details of all matched trades may be provided back to dealers. Exemplary embodiments of the trading system graphical user interface after the sweep is completed are illustrated in FIGS. 8 and 9. For example, for each tenor (i.e., as designated by start date column 85 and end date column 86), the trading system graphical user interface may report the size in column 310 and rate in column 320 of any matched trades. Because the trading system may not match the full trade size the dealer had entered into the sweep, the trading system graphical user interface may also display the desired trade size (i.e., column 330) in addition to the matched trade size (i.e., column 320).

In embodiments where trades are completed using a clearing house such as LCH.Clearnet's RepoClear, the trading system, for example, via a pre-execution module, may additionally report the matched trades to the clearing house using a standardized messaging protocol such as the MT518 Market-Side Securities Trade Confirmation specification, the contents of which are herein incorporated by reference. It should be appreciated that any clearing house methodology and messaging protocol can be used as can be appreciated by one of ordinary skill in the art. Details of missed matches due to price tolerance outside market mid may also be provided back to dealers.

Repo transactions may include the exchange of general collateral at the beginning and at the maturity of the contract. Alternately, repo transactions may use a tri-party, a custodian bank or clearing house (the tri-party agent) acting as an intermediary between the parties to the repo trade, where the tri-party agent holds the repo collateral. Tri-party agents may facilitate basket transactions where a party's collateral may be aggregated and may shift in value from day-to-day. For example, where tri-party agents hold repo collateral, some bonds collateralizing the repos may change in value as those bonds are traded. Aggregate collateral in tri-party baskets is safer than generalized collateral. Accordingly, in an exemplary embodiment, a computerized electronic trading system and method trading system permits dealers to use their tri-party baskets to fund trades.

The trading system according to one embodiment of the present invention transforms bids and offers from dealer interest into mids which may be used as proposed rates to trade and may be used to generate a yield curve. The subsequent yield curve of mids may be used for the valuation of positions and collateral using the same. The use of computers allows the expression of dealer interest in an anonymous environment which may generate more price interest than in the current voice broker environment. This in combination with the mid price generation process and use of CCP baskets to identify and effect balance sheet reductions is a significant improvement on current methods.

It should be noted that although the embodiments described may use multiple software modules for performing the various functions of the system, other embodiments could be implemented using any number of modules, with any single module incorporating the functions of several, or all, of the modules. The precise design of the software and the programming language used may be designed differently within the scope of the present invention. The software modules can be created using art recognized programming languages, including but not limited to C++, ASP, Java, C#, ASP.NET, or PHP or any combination of known or later developed programming languages that allow the functionality described.

It will also be understood that, although the various embodiments of the present invention described herein are being described in terms of web-based centralized server architecture, a thin client, fat-client, or peer-to-peer type arrangement could be substituted for the system architecture described herein and are within the scope of the present invention. Additionally, the programming described herein can be stored in a machine readable form on a computer readable medium, such as a CD-ROM or DVD, and distributed to users for installation on user computers. Alternatively, such programming can be downloaded via network. In either embodiment, communication with the system may be effected across known networks, such as the Internet.

It should be noted that references herein to phrases such as “one embodiment” or “an embodiment” means that a particular feature, structure or characteristic described in connection with the embodiment is included in at least one embodiment of the invention. The phrases such as “in one embodiment” or “in certain embodiments” in various places in the specification are not necessarily, but can be, referring to the same embodiment. Use of the term “preferred” or “preferably” is intended to indicate a configuration, set-up, feature, process, or alternative that may be perceived by the inventor(s) hereof, as of the filing date, to constitute the best, or at least a better, alternative to other such configurations, set-ups, features, processes, or alternatives. In no way shall the use of the term “preferred” or “preferably” be deemed to limit the scope of the claims hereof to any particular configuration, set-up, feature, process, or alternative.

It will be further appreciated by those skilled in the art that the figures are purely illustrative, and that the system may be implemented in any number of ways, by the actual designers, as long as the functionality as described above, stays intact. Furthermore, with regard to one or more of the figures, diagrams, and/or charts shown herein, due to limitation in capturing the entire screenshot into one picture, such figures, diagrams, and/or charts depict exemplary embodiments of the described subject matter taken in pieces that reference other pieces.

While there have been shown and described fundamental novel features of the invention as applied to the exemplary embodiments thereof, it will be understood that omissions and substitutions and changes in the form and details of the disclosed invention may be made by those skilled in the art without departing from the broad inventive concept thereof. It is understood, therefore, that this invention is not limited to the particular embodiments disclosed, but it is intended to cover modifications within the spirit and scope of the present invention. It should also be understood that where a claim element is intended to be expressed as a means or step for performing a specified function, such element has been expressly identified with the language “means for”. In the absence of such express language, 35 U.S.C. §112, paragraph 6 should not be invoked.

1. A system for generating one or more pre-trade prices and matching trades, the system in communication with a plurality of dealers associated with a plurality of dealer computer systems, the system comprising:
an order entry module with one or more sub-routines operative to accept trade order data from the plurality of dealers;
a rate generation module with one or more sub-routines operative to generate one or more pre-trade prices based on the trade order data;
a size confirmation module with one or more sub-routines operative to permit the plurality of dealers to provide updated trade order data based on the one or more pre-trade prices;
a sweep module with one or more sub-routines operative to match trades based on the updated trade order data and to execute the matched trades;
a trade reporting module with one or more sub-routines operative to provide each dealer who matched a trade with trade data for each trade matched by that dealer.

2. The system of claim 1 wherein the trade order data includes risk limits.

3. The system of claim 1 wherein the one or more pre-trade prices maximize trade volume.

4. The system of claim 1 further comprising:
a volatility module with one or more sub-routines operative to generate an indication of market volatility, wherein the indication activates a volatility notification to one or more dealers and permits the one or more dealers to cancel a trade session.

5. The system of claim 1 wherein the trade reporting module includes one or more sub-routines operative to provide matched trade data to at least one or more settlement agents or to one or more clearers.

6. The system of claim 1 wherein a dealer is not provided with opposing dealer positions unless the dealer matches a trade.

7. A method for generating one or more pre-trade prices and matching trades, the method comprising:
accepting trade order data from a plurality of dealers associated with a plurality of dealer computer systems;
generating one or more pre-trade prices based on the trade order data;
permitting the plurality of dealers to provide updated trade order data based on the one or more pre-trade prices;
matching trades based on the updated trade order data;
executing the matched trades;
providing each dealer who matched a trade with trade data for each trade execution matched by that dealer.

8. The method of claim 7 wherein the trade order data includes risk limits.

9. The method of claim 7 wherein the one or more pre-trade prices maximize trade volume.

10. The method of claim 7 further comprising:
generating an indication of market volatility, wherein the indication activates a volatility notification to one or more dealers and permits the one or more dealers to cancel a trade session.

11. The method of claim 7 further comprising:
providing at least one or more settlement gents or one or more clearers with matched trade data.

12. The method of claim 7 wherein a dealer is not provided with opposing dealer positions unless the dealer matches a trade.

13. A system for generating one or more pre-trade prices and matching trades, the system in communication with a plurality of dealers associated with a plurality of dealer computer systems, the system comprising:
an order entry module with one or more sub-routines operative to accept trade order data from the plurality of dealers;
means for generating one or more pre-trade prices based on the trade order data;
a size confirmation module with one or more sub-routines operative to permit the plurality of dealers to provide updated trade order data based on the one or more pre-trade prices;
a sweep module with one or more sub-routines operative to match trades based on the updated trade order data and to execute the matched trades;
a trade reporting module with one or more sub-routines operative to provide each dealer who matched a trade with trade data for each trade matched by that dealer.

14. The system of claim 13 wherein the trade order data includes risk limits.

15. The system of claim 13 wherein the one or more pre-trade prices maximize trade volume.

16. The system of claim 13 further comprising:
a volatility module with one or more sub-routines operative to generate an indication of market volatility, wherein the indication activates a volatility notification to one or more dealers and permits the one or more dealers to cancel a trade session.

17. The system of claim 13 wherein the trade reporting module includes one or more sub-routines operative to provide matched trade data to at least one or more settlement agents or to one or more clearers.

18. The system of claim 13 wherein a dealer is not provided with opposing dealer positions unless the dealer matches a trade.
